(19) United States
(12) Patent Application Publication
(10) Pub. No.: US 2026/0326480 A1
(43) Pub. Date: Oct. 22, 2026

(54) HUBCAP ASSEMBLY WITH OIL FILTER AND THREADED ENDCAP

(71) Applicant: Adam Price, Springfield, OH (US)

(72) Inventor: Adam Price, Springfield, OH (US)

(21) Appl. No.: 19/181,238

(22) Filed: Apr. 16, 2025

(51) Int. Cl. B60B 7/00; B60B 7/04; B60B 7/06; B60B 7/14

(52) U.S. Cl. CPC B60B 7/0013; B60B 7/04; B60B 7/066; B60B 7/14; B60B 2900/211; B60B 2900/561

(57) ABSTRACT

A hubcap assembly is configured to be mounted onto a wheel hub and includes a hubcap body that forms an enclosure that may contain oil to lubricate wheel bearings. The hubcap assembly includes a cap assembly that is configured to cap an open distal end of the hubcap body to seal the enclosure. The cap assembly includes a threaded endcap having helical threads that are compatible with helical threads at the distal end of the hubcap body. A filter element may be secured to the threaded endcap so that the filter element is positioned within the enclosure when the threaded endcap is threaded onto the hubcap body. The filter element may include magnetic components for magnetic separation of metal shavings contained in oil within the enclosure, barrier filtration media for removal of other contaminants from the oil, or a combination of magnetic components and barrier filtration media.

### FIELD OF THE DISCLOSURE

The present disclosure relates to hubcap assemblies for vehicle wheels, and more particularly to a hubcap assembly with a threaded endcap and an integrated oil filter for filtering oil for wheel bearings.

### BACKGROUND

Hubcaps have long been used on vehicle wheels to protect wheel components and provide an aesthetically pleasing appearance. In heavy-duty vehicle applications, such as large trucks and trailers, hubcaps are often designed for the specific function of containing lubricating oil for wheel bearings. These oil-containing hubcaps have an oil reservoir to hold a supply of oil that lubricates the wheel bearings during operation of the vehicle. While oil lubrication can extend the life of wheel bearings compared to grease lubrication, the oil in the hubcap reservoir can become contaminated over time. Metal particles, dirt, debris, and other contaminants can accumulate in the oil as the bearings wear or as external elements enter the hubcap. This contamination can reduce the effectiveness of the lubrication and potentially lead to increased wear or damage to the bearings. Periodic oil changes are typically performed to remove contaminated oil and replenish the oil reservoir with fresh oil. However, this maintenance task requires time and labor and results in vehicle downtime. There is a general desire in the industry to extend the intervals between oil changes while still maintaining proper lubrication of wheel bearings.

Filtration is a common technique used in other lubrication systems for vehicles, such as engine oil systems, or other types of motors used in various applications to remove contaminants and extend the useful life of the lubricating oil. However, the use of filtration systems in oil-containing hubcaps is generally lacking in the industry. Integrating effective filtration into the limited space of a wheel hubcap presents challenges. Any filtration system added to a hubcap must be compact but also capable of effectively filtering various types of contaminants from the oil while maintaining proper bearing lubrication. Such a filtration system should also be durable to withstand harsh operating conditions and configured to allow sufficient oil flow throughout the interior of the hubcap. The filter portion of such a filtration system should also be easy to install and remove from the hubcap for cleaning or replacement with minimal steps and minimal removal of other components of the hubcap or filtration system. Such improvements have the potential to extend oil change intervals, reduce maintenance costs, and improve overall wheel-end reliability for heavy-duty vehicles.

### SUMMARY

In one aspect, a hubcap assembly is provided. The hubcap assembly comprises a hubcap body configured to be mounted onto a wheel hub and a cap assembly configured to cap an open distal end of the hubcap body. The hubcap body has an interior wall that defines an enclosure that may contain oil to lubricate wheel bearings. The wheel bearings support a wheel hub on which a wheel is mounted. The wheel hub and wheel may be mounted onto any suitable type of axle or spindle of any type of vehicle or trailer towed by a vehicle. The cap assembly includes a threaded endcap having helical threads that are compatible with helical threads on the hubcap body so that the endcap may be used to cap the open end of the hubcap body to seal the enclosure. The hubcap body may have a mounting flange having a plurality of openings extending through the mounting flange for mounting the hubcap body onto the wheel hub using bolts.

In a preferred embodiment, the cap assembly further comprises a filter element configured to remove at least one type of contaminant from oil contained in the enclosure. The filter element may comprise a barrier filtration media, one or more magnets configured to remove metal shavings from the oil, or a combination of magnets and barrier filtration media. The barrier filtration media may be utilized to remove dirt, debris, or any other type of contaminant capable of being removed through barrier filtration of oil. The filter element is preferably secured to the cap assembly so that the filter element is disposed within the enclosure when the threaded endcap is threaded onto the open distal end of the hubcap body. A holding chamber may be disposed between the filter element and a distal end of the threaded endcap.

In a preferred embodiment, the cap assembly comprises the threaded endcap, a fastening ring, a transparent viewing window having an opening extending through the viewing window, and a plug configured to be installed within the opening in the viewing window to seal the opening. The fastening ring may be fastened to the threaded endcap to retain the viewing window in a fixed position on the endcap and form a seal around the viewing window. The threaded endcap may preferably further comprise a filter retaining structure configured to support the filter element in a fixed position between the filter retaining structure and the viewing window. Thus, the cap assembly may be assembled into a single unitary assembly including the filter element and the viewing window, and the unitary assembly may be threaded onto the open distal end of the hubcap body to cap the hubcap body and seal the enclosure.

In another embodiment, the filter retaining structure comprises a filter support plate that is not directly attached to the threaded endcap by a structural attachment. The support plate has openings extending through the support plate to allow oil to flow through the filter element that is retained by the support plate. Because the filter retaining structure is not directly attached to the threaded endcap, the filter element may be removed from the hubcap assembly when the threaded endcap is removed from the hubcap body.

The filter element has openings that define passageways that allow the flow of oil between the enclosure on a proximal side of the filter element and the holding chamber on a distal side of the filter element. The transparent viewing window allows a user to view an oil level within the holding chamber from an exterior of the hubcap. As oil moves within the interior of the hubcap body and through the filter element during operation of the vehicle, the filter element removes contaminants from the oil and retains the contaminants on or within the filter element. The design of the filter element effectively removes contaminants from the oil to extend the life of the oil between oil changes and thus enhance bearing lubrication through extended periods of use.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a wheel hub assembly with a hubcap in accordance with the present disclosure.

FIG. 2 shows a perspective view of a hubcap assembly for installation on a wheel hub in accordance with the present disclosure.

FIG. 3 shows a perspective view of an alternative embodiment of a hubcap assembly for installation on a wheel hub in accordance with the present disclosure.

FIG. 4 shows a front view of a hubcap assembly for installation on a wheel hub in accordance with the present disclosure.

FIG. 5 shows an exploded view of a hubcap assembly in accordance with the present disclosure.

FIG. 6 shows a perspective view of a threaded endcap for a hubcap assembly in accordance with the present disclosure.

FIG. 7 shows a front view of a threaded endcap for a hubcap assembly in accordance with the present disclosure.

FIG. 8 shows a side view of a threaded endcap for a hubcap assembly in accordance with the present disclosure.

FIG. 9 shows a cross-sectional view of a threaded endcap for a hubcap assembly in accordance with the present disclosure.

FIG. 10 shows a cross-sectional view of a hubcap assembly in accordance with the present disclosure.

FIG. 11 shows a plan view of a filter element for use with a hubcap assembly in accordance with the present disclosure.

FIG. 12A shows a side view of a filter element for use with a hubcap assembly in accordance with the present disclosure.

FIG. 12B shows a cross-sectional view of a filter element for use with a hubcap assembly in accordance with the present disclosure.

FIG. 13 shows a perspective view of a filter element for use with a hubcap assembly in accordance with the present disclosure.

FIG. 14 shows a plan view of a filter element for use with a hubcap assembly in accordance with the present disclosure.

FIG. 15 shows an exploded view of a filter element for use with a hubcap assembly in accordance with the present disclosure.

FIG. 16 shows a perspective view of a filter element for use with a hubcap assembly in accordance with the present disclosure.

FIG. 17 shows a perspective view of a filter element for use with a hubcap assembly in accordance with the present disclosure.

FIG. 18 shows a plan view of a filter element for use with a hubcap assembly in accordance with the present disclosure.

FIG. 19 shows a cross-sectional view of a filter element for use with a hubcap assembly in accordance with the present disclosure.

FIG. 20 shows a cross-sectional view of a filter element for use with a hubcap assembly in accordance with the present disclosure.

FIG. 21 shows a perspective view of a wheel hub assembly with an alternative embodiment of a hubcap assembly in accordance with the present disclosure.

FIG. 22 shows an exploded view of an alternative embodiment of a hubcap assembly in accordance with the present disclosure.

FIG. 23 shows a cross-sectional view of an alternative embodiment of a hubcap assembly in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

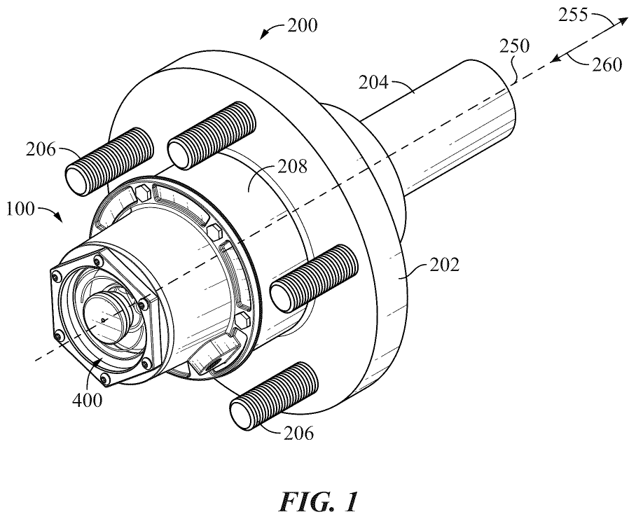

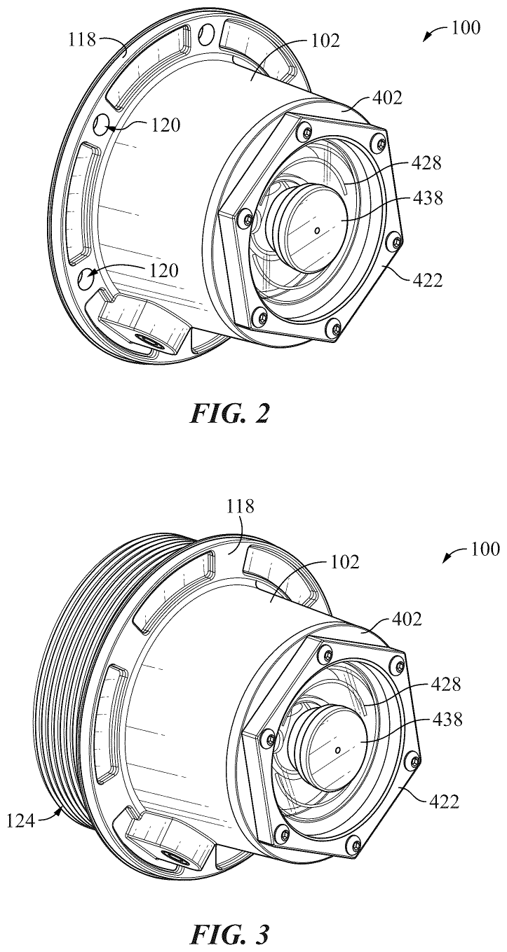

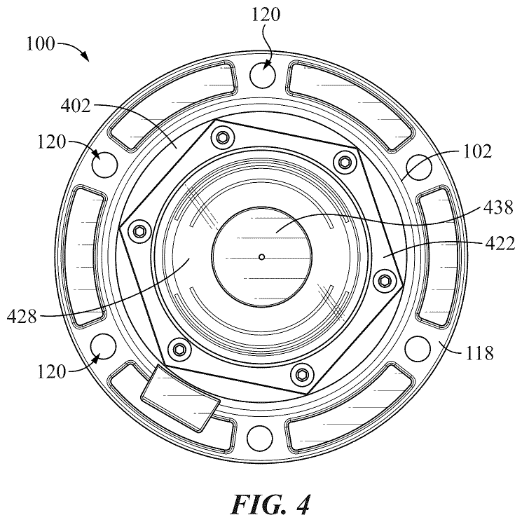

In one aspect, a hubcap assembly 100 is provided. The hubcap assembly 100 comprises a hubcap body 102 configured to be removably mounted onto a wheel hub 202. FIG. 1 shows a wheel hub assembly 200 with the hubcap assembly 100 installed thereon, and FIGS. 2-4 show the hubcap assembly 100 removed from the wheel hub assembly 200. The hubcap body 102 has an interior wall 104 that defines an enclosure 108 that may contain oil to lubricate wheel bearings. The hubcap assembly 100 further comprises a cap assembly 400 configured to cap an open distal end 112 of the hubcap body 102. The cap assembly 400 comprises a threaded endcap 402 having helical threads 404 that are compatible with helical threads 116 on the hubcap body 102 so that the endcap 402 may be used to cap the open distal end 112 of the hubcap body 102 to seal the enclosure 108. In a preferred embodiment, the cap assembly 400 further comprises a filter element 300 configured to remove at least one type of contaminant from oil contained within the enclosure 108.

The wheel hub assembly 200 comprises a wheel hub 202 rotatably coupled to and positioned around an axle 204 of a vehicle. The wheel hub 202 is supported on the axle 204 by at least one bearing so that the hub 202 and wheel mounted thereon may rotate about the axle 204. As used herein, an “axle” may refer to any component of a vehicle that provides a structure for rotatably coupling a wheel hub 202 thereto. The vehicle may include any type of motorized or non-motorized vehicle having wheels that may be used for transporting people or goods, including, but not limited to, motorized vehicles such as a tractor unit of a semi-trailer or tractor-trailer, dump trucks, buses, cars, recreational vehicles (RV), motor homes, farm equipment, mining vehicles, electric conveyance vehicles (ECV), or aircraft, and non-motorized vehicles such as a trailer or semi-trailer, which may include enclosed cargo trailers, flatbed trailers, boat trailers, vehicle trailers, livestock trailers, or dollies. The wheel hub 202 may have outwardly facing bolts 206 for mounting a wheel on the hub 202. The hub 202 rotates about a central axis 250 when the vehicle is in motion so that the wheel mounted on the hub 202 rotates with the hub 202. As used herein, an axially inward direction refers to a direction extending toward the axle 204, and an axially outward direction refers to a direction extending away from the axle 204 toward the cap assembly 400 that is accessible from the exterior of the hubcap assembly 100. As illustrated in FIG. 1, arrow 255 indicates an axially inward direction, and arrow 260 indicates an axially outward direction. As used herein, a “distal” end or “distal” side of any component of the hubcap assembly 100 or a “distal” direction refers to an end, side, or direction toward the axially outward direction 260. Similarly, a “proximal” end or “proximal” side of any component of the hubcap assembly 100 or a “proximal” direction refers to an end, side, or direction toward the axially inward direction 255.

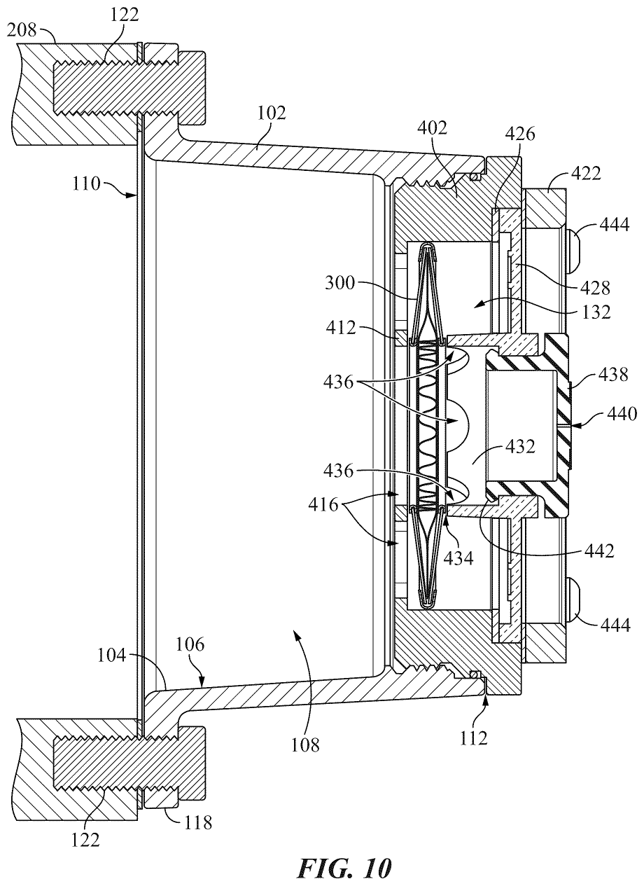

The hubcap body 102 has a proximal end 110 and a distal end 112. A central opening 114 extends through the hubcap body 102 from the proximal end 110 to the distal end 112 to define an opening at the proximal end 110 and an opening at the distal end 112. The proximal end 110 of the hubcap body 102 preferably has a plurality of fastener openings 120 configured for removably mounting the hubcap body 102 onto the wheel hub 202 using a plurality of fasteners 122. As shown in FIG. 2, the proximal end 110 of the hubcap body 102 may have a mounting flange 118, and each of the plurality of fastener openings 120 extends through the flange 118 for fastening the flange 118 of the hubcap body 102 to the wheel hub 202 using bolts 122 or a similar type of threaded fastener, as best seen in FIGS. 1 and 10. The wheel hub 202 may have a hubcap assembly 100 mounting portion 208 that extends axially outward from the hub 202. The mounting portion 208 of the wheel hub 202 may have corresponding threaded bolt holes for fastening the flange 118 onto the wheel hub 202 using bolts 122 inserted through the openings 120 in the flange 118 and into the corresponding bolt holes of the mounting portion 208 of the wheel hub 202.

Alternatively, as shown in FIG. 3, the proximal end 110 of the hubcap body 102 may have helical threads 124, and the mounting portion 208 of the wheel hub 202 may have corresponding helical threads configured to mate with helical threads 124 attached to the hubcap body 102 for mounting the hubcap body 102 onto the wheel hub 102. In this case, the threads 124 on the hubcap body 102 may be right-hand threads, and the threads 404 on the threaded endcap 402 may be left-hand threads, or vice versa.

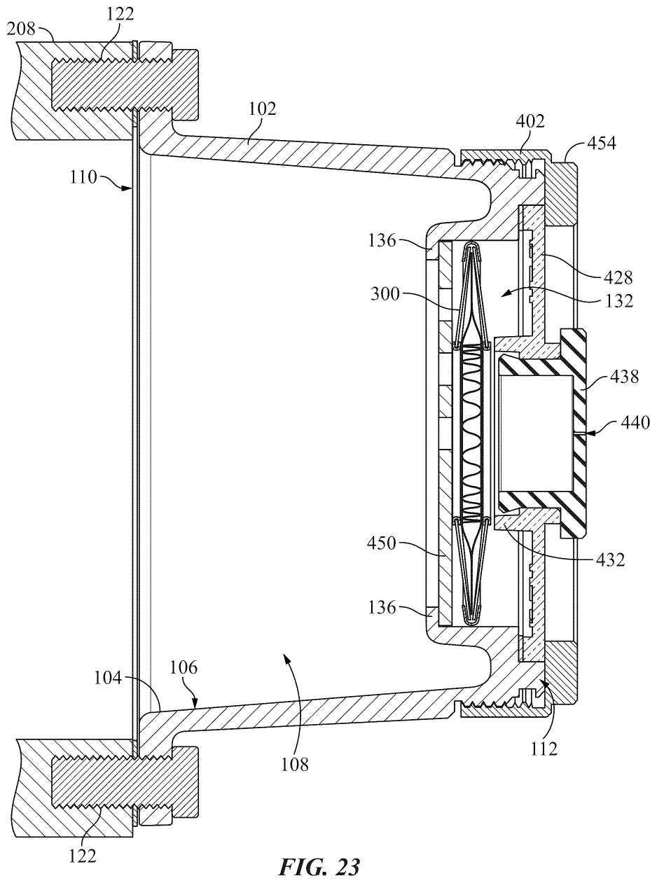

As best seen in FIG. 10, the hubcap body 102 may be slightly tapered as the body 102 extends toward the distal end 112, in which case the body 102 may have a truncated conical shape. Alternatively, the hubcap body 102 may have a generally cylindrical shape or another suitable shape. The hubcap body 102 is generally a housing having a continuous sidewall that forms the enclosure 108. As shown in FIG. 10, an interior side of the sidewall of the body 102 forms the interior wall 104, which has an interior surface 106 that extends continuously around a perimeter of the enclosure 108. The filter element 300 is secured to the cap assembly 400 when the cap assembly 400 is assembled. The filter element 300 is disposed within the enclosure 108 containing oil, and a portion of the oil enclosure 108 that may be disposed on a distal side of the filter element 300 defines a holding chamber 132, as shown in FIGS. 10 and 23. The holding chamber 132 portion of the oil enclosure 108 may be disposed between the filter element 300 and a viewing window 428 or other portion of the cap assembly 400. The holding chamber 132 is a space that may hold a portion of the oil contained within the oil enclosure 108 and provides a space that allows the oil to flow across the filter element 300.

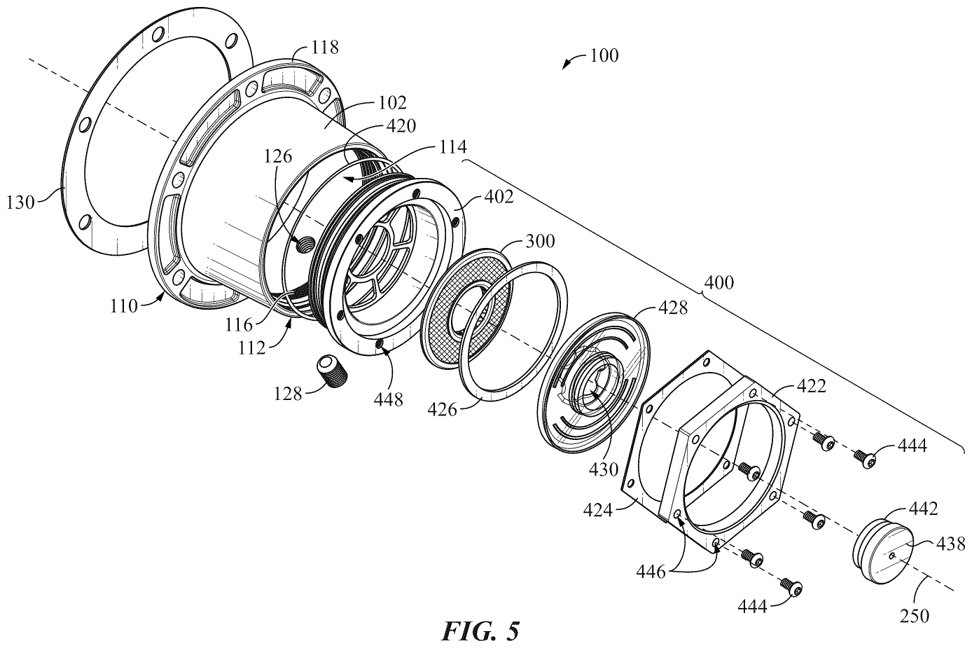

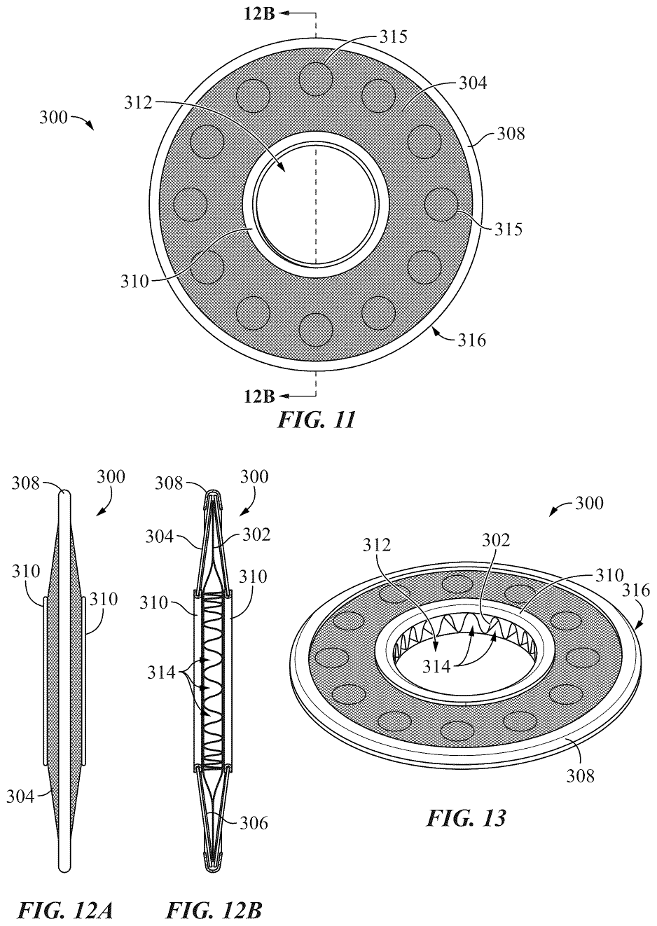

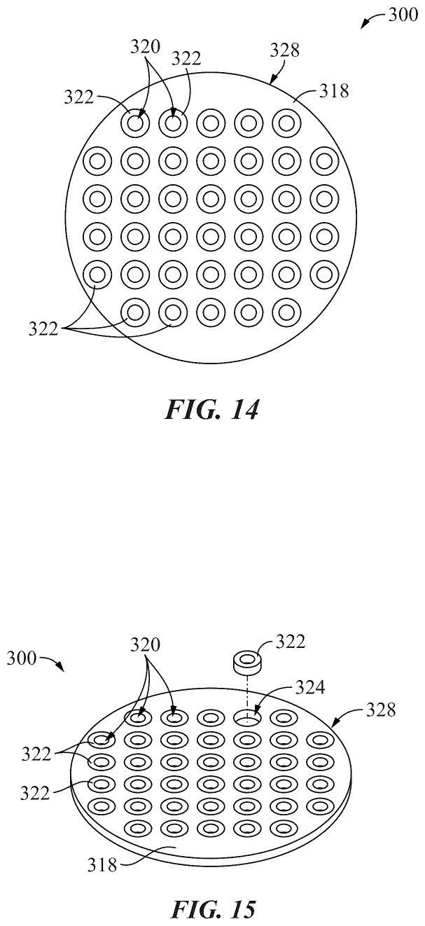

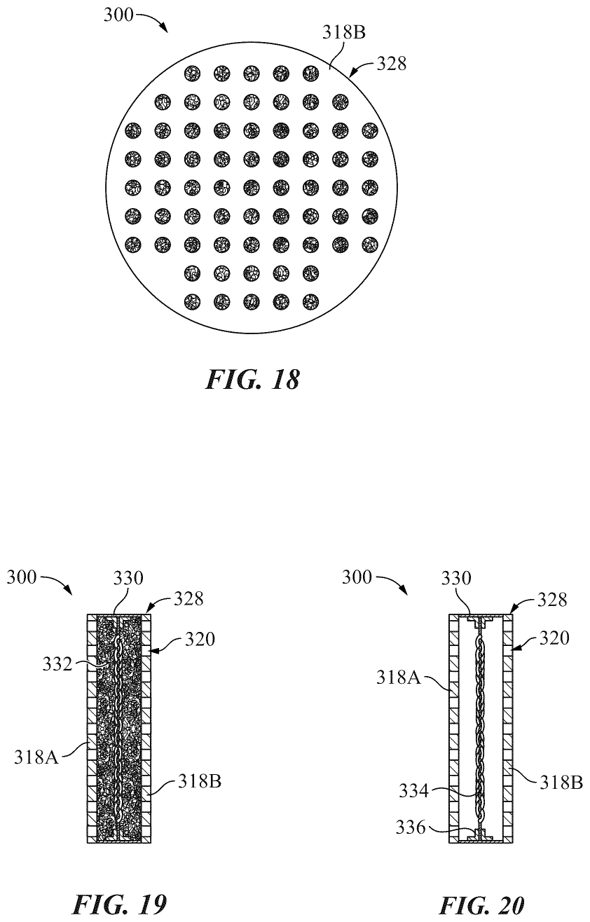

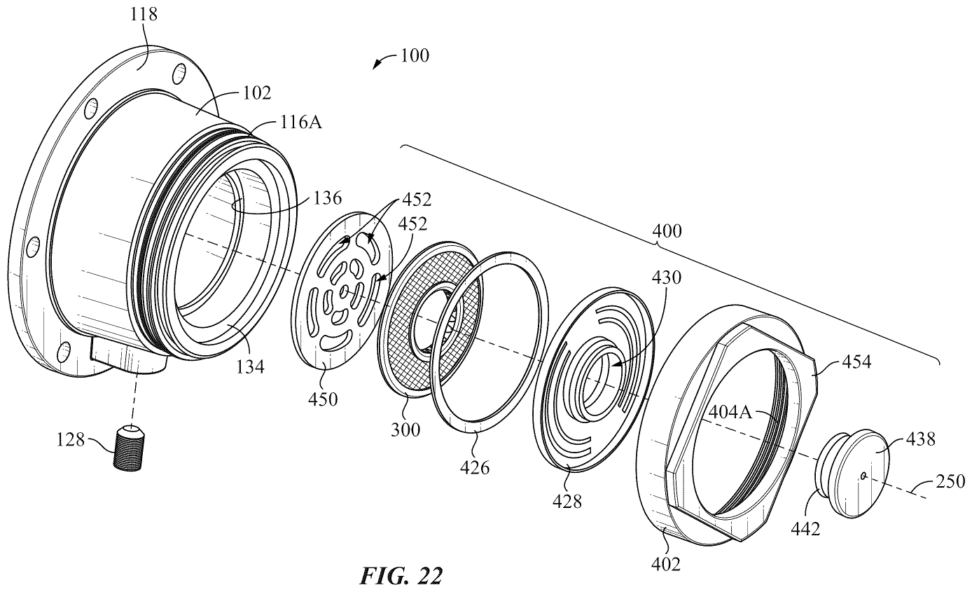

The hubcap body 102 has a threaded section having helical threads 116 at the distal end 112 of the hubcap body 102. In a preferred embodiment, the helical threads 116 of the threaded section of the distal end 112 of the hubcap body 102 may comprise female threads disposed on an interior side of the interior wall 104 of the hubcap body 102, and the helical threads 404 of the threaded endcap 402 may comprise male threads, as shown in FIGS. 5 and 10. Alternatively, as shown in FIGS. 22 and 23, the helical threads 116A of the threaded section of the distal end 112 of the hubcap body 102 may comprise male threads disposed on an exterior side of a wall of the hubcap body 102, and the helical threads 404A of the threaded endcap 402 may comprise female threads. FIGS. 1-10 illustrate the endcap 402 with male threads 404 and the hubcap body 102 with female threads 116, in which case the cap assembly 400 may be assembled into a single unitary assembly including the filter element 300 and the viewing window 428, and the unitary assembly may be threaded onto the open distal end 112 of the hubcap body 102 to cap the hubcap body 102 and seal the enclosure 108, as best seen in FIG. 10. FIGS. 11-13 illustrate the filter element 300 shown in FIGS. 5, 10, 22, and 23. FIGS. 14-20 show other possible embodiments of the filter element 300 that may be utilized with the present hubcap assembly 100. It should be understood by one of skill in the art that other embodiments of the filter element 300 may also be utilized and still fall within the scope of the present disclosure.

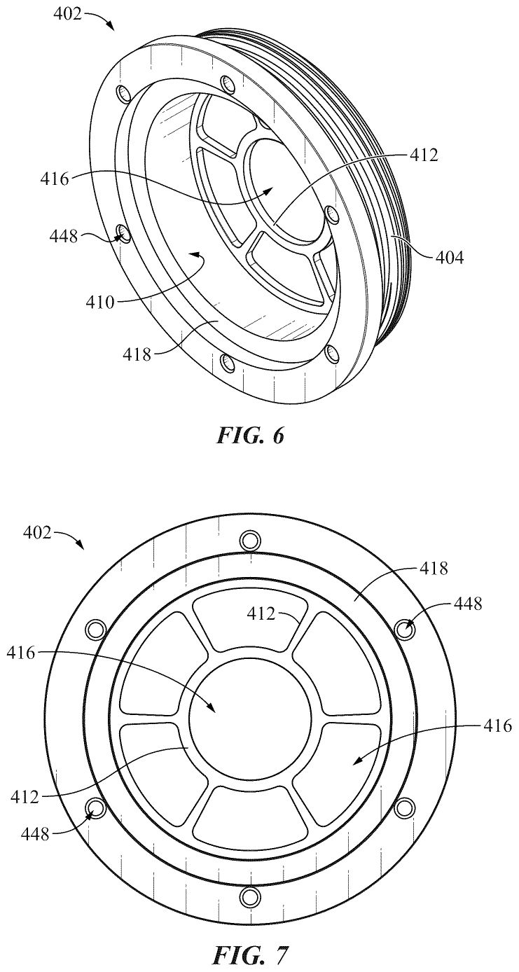

FIGS. 6-9 illustrate the threaded endcap 402. The endcap 402 has a proximal end 406 and a distal end 408. The threaded endcap 402 may have an interior wall 410 extending around an inner perimeter of the threaded endcap 402. The interior wall 410 is disposed between the proximal end 406 and the distal end 408. As best seen in FIGS. 6 and 9, the proximal end 406 of the endcap 402 preferably comprises a filter retaining structure 412 that extends transversely across a width 414 of the threaded endcap 402 between opposing surfaces of the interior wall 410. The filter retaining structure 412 is configured to support the filter element 300 in a transverse position relative to the threaded endcap 402 and relative to axis 250 when the endcap 402 is threaded onto the hubcap body 102. The filter retaining structure 412 defines at least one opening 416 extending through the filter retaining structure 412. The openings 416 are preferably relatively large to maximize oil flow through the filter element 300. The filter retaining structure 412 is preferably permanently attached to the endcap 402 and extends across the proximal end 406 between portions of the interior wall 410 to provide support to the filter element 300 when the filter element 300 is placed against the retaining structure 412. As best seen in FIG. 7, the filter retaining structure 412 preferably includes multiple interconnected members to provide sufficient support to the filter element 300. In a preferred embodiment, the filter retaining structure 412 is configured to support the filter element 300 in a generally fixed position between the filter retaining structure 412 and the viewing window 428, as best seen in FIG. 10. The filter element 300 is preferably not structurally attached to any other component of the cap assembly 400 but instead may be sandwiched between other components so that the filter element 300 is retained in place during normal use.

The filter element 300 extends transversely across the width 414 defined by the interior wall 410 of the endcap 402, preferably around a circular perimeter of the interior wall 410. As best seen in FIG. 10, the filter element 300 may preferably extend transversely across a maximum width 414 of the interior of the endcap 402. The filter element 300 is preferably disposed in a position generally perpendicular to the interior wall 410 of the endcap 402. Preferably, the filter element 300 has a generally circular shape that defines an outer peripheral edge 316, 328 of the filter element 300, and the outer peripheral edge 316, 328 of the filter element 300 generally conforms to a generally circular interior shape of the interior wall 410 of the endcap 402 such that the filter element 300 extends transversely across substantially all of a cross-sectional area defined by the interior wall 410. Optionally, the filter element 300 may have an outer diameter that is slightly smaller than the width 414 defined by the interior wall 410 of the endcap 402 such that there is a small gap between the filter element 300 and the interior wall 410 of the endcap 402 around a perimeter of the filter element 300 to allow a minimal amount of oil to bypass the filter element 300 to ensure that oil can move between the holding chamber 132 and portions of the oil enclosure 108 on the proximal side of the filter element 300 in the event that the filter element 300 becomes clogged after a period of use, which may allow oil levels in the enclosure 108 to equalize on opposite sides of the filter element 300 to ensure that the oil level inside the hubcap body 102 is always visible from the exterior of the hubcap assembly 100 through the viewing window 128. The endcap 402 may be designed to maximize the interior width 414 of the endcap 402 so that the diameter of the filter element 300 may be maximized to also maximize the volume of oil that may be filtered.

As best seen in FIG. 5, the hubcap body 102 may have a drain port 126 that is closed during normal use by a drain plug 128. The drain port 126 may be defined by a threaded opening having threads that are compatible with threads on the drain plug 128 to allow the drain plug 128 to seal the drain port 126 closed and to remove the drain plug 128 to drain oil from the oil enclosure 108 to periodically change the oil. The drain port 126 is positioned on a proximal side of the filter element 300. Fresh oil may also be added into the oil enclosure 108 through the drain port 126 after draining the used oil.

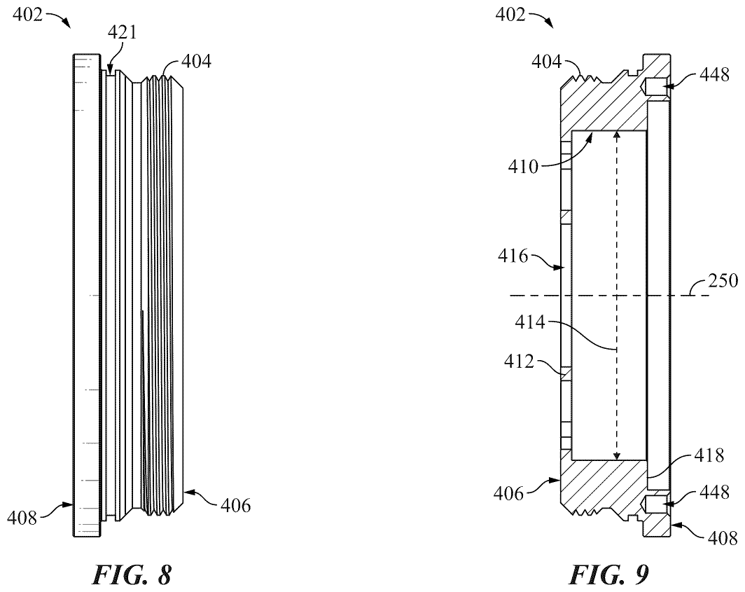

FIG. 5 shows an exploded view of the hubcap assembly 100 utilizing the filter element 300 shown in FIGS. 11-13. As best seen in FIGS. 5 and 10, the cap assembly 400 may comprise a fastening ring 422, a transparent viewing window 428 having an opening 430 extending through the viewing window 428, and a plug 438 configured to be installed within the opening 430 in the viewing window 428 to seal the opening 430. The fastening ring 422 is configured to be removably secured to the threaded endcap 402 and to retain the viewing window 428 in a fixed position on the endcap 402. The cap assembly 400 may further comprise a distal gasket 424 and a proximal gasket 426 positioned on opposite sides of the viewing window 428 to form a seal around the viewing window 428. As best seen in FIGS. 6 and 9, the threaded endcap 402 may have an interior edge 418 sized and configured so that the proximal gasket 426 may be positioned flat against the interior edge 418 when installed. The transparent viewing window 428 may then be placed against the proximal gasket 426, and the distal gasket 424 may be placed against the opposing distal side of the viewing window 428. To complete the assembly of the cap assembly 400, the fastening ring 422 may be placed against the distal gasket 424, as shown in FIG. 10, and the fastening ring 422 may be fastened to the threaded endcap 402 using bolts 444 or similar types of fasteners. As shown in FIG. 5, the fastening ring 422 may have bolt openings 446 for insertion of the bolts 444 therethrough, and the distal end 408 of the threaded endcap 402 may have corresponding threaded openings 448 compatible with threads on bolts 444 and configured to receive bolts 444 therein to tightly secure the components of the cap assembly 400 together so that oil enclosure 108 is sealed around the viewing window 428. The distal gasket 424 may generally have the same shape as the fastening ring 422 and may also have corresponding openings so that the bolts 444 may be inserted through the distal gasket 424. The fastening ring 422 may have a hex shape or other similar shape suitable for engagement with a wrench to apply torque to the cap assembly 400 for installing or removing the cap assembly 400 from the hubcap body 402. Alternatively, another component of the cap assembly 400 may be shaped for engagement with a wrench. The cap assembly 400 may also include a rubber O-ring 420, which may be sized to fit into a groove 421 disposed around a perimeter of the threaded endcap 402, as best seen in FIG. 8. The O-ring may form a seal around the threaded endcap 402 when the endcap 402 is threaded onto the hubcap body 102 so that the open distal end 112 of the hubcap body 102 is sealed, thereby sealing the oil enclosure 108 to prevent leakage of oil and keep outside contaminants from entering the enclosure 108 through the sealed components. The hubcap assembly 102 may also include a gasket 130 sized to fit between the flange 118 of the hubcap body 102 and the mounting portion 208 of the wheel hub 202 to form a seal between the hubcap body 102 and wheel hub 202. The gasket 130 may have corresponding openings so that bolts 122 may be inserted through the gasket 130 when fastening the hubcap body 102 to the wheel hub 202.

The plug 438 may then be installed within the opening 430 in the viewing window 428 to seal the opening 430. The plug 438 may be made of a deformable elastomeric material, such as rubber or a similar polymeric material, and may have a lip 442 extending around a perimeter of a proximal end of the plug 438 to retain the plug 438 within opening 430 after insertion into the opening 430. As best seen in FIG. 10, the plug 438 may have a pressure relief opening 440 extending through the plug 438. The pressure relief opening 440 may be a slit or small borehole extending through the plug 438 to allow equalization of pressure between the interior of the hubcap body 102 and the external atmosphere while preventing or minimizing any amount of dirt, debris, or moisture that may enter the enclosure 108 through the opening 440 and also preventing or minimizing any potential leakage of oil from the enclosure 108.

Before installation of the viewing window 128 and fastening ring 422 onto the threaded endcap 402, the filter element 300 may be placed within the area of the endcap 402 defined by interior wall 410 with the filter element 300 generally positioned against the filter retaining structure 412. In a preferred embodiment, as best seen in FIG. 10, the viewing window 428 may comprise an extension element 432 that extends from the viewing window 428 in an axially inward direction when the viewing window 428 is retained in a fixed position by the fastening ring 422. The extension element 432 is configured to retain the filter element 300 in a position between the extension element 432 and the filter retaining structure 412. The extension element 432 is sized and configured to retain the filter element 300 in a generally fixed position within the cap assembly 400, though there may be small gaps on one or both sides of the filter element 300 between the filter element 300 and the extension element 432 and/or the filter retaining structure 412. The filter retaining structure 412, extension element 432 of the viewing window 428, and the interior wall 410 of the endcap 402 retain the filter element 300 within the endcap 402, though the filter element 300 is preferably not directly attached to any part of the cap assembly 400 by a structural component.

The extension element 432 has a peripheral edge 434 that extends continuously around the opening 430 extending through the viewing window 428. In a preferred embodiment, as best seen in FIG. 10, the peripheral edge 434 of the extension element 432 defines a plurality of indentations 436 formed in the peripheral edge 434 around the perimeter of the peripheral edge 434 and thus around the perimeter of opening 430. The indentations 436 form additional passages through which oil may flow to increase the circulation of oil into the holding chamber 132 and through the filter element 300.

Once the cap assembly 400 is fully assembled with the filter element 300, viewing window 428, fastening ring 422, plug 438, and gaskets 424 and 426, the cap assembly 400 forms a single unitary assembly that may be threaded as a single unit onto the open distal end 112 of the hubcap body 102 to cap the hubcap body 102 and seal the enclosure 108. The cap assembly 400 may be tightened onto the hubcap body 102 by engaging the fastening ring 422 with a wrench to ensure the hubcap assembly 100 is fully sealed when installed on the wheel hub 202. When the hubcap body 102 is mounted on a wheel hub 202 and the cap assembly 400 is removed from the hubcap body 102, the open distal end 112 of the hubcap body 102 allows access into the enclosure 108, which also allows access to the torque nut, spindle nut, or other type of fastener used to fasten the wheel hub 202 to the axle 204 of the vehicle. Thus, the torque nut may be tightened or otherwise adjusted as necessary without removing the hubcap body 102 from the wheel hub 202. The torque nut may also be loosened and removed through the open distal end 112 of the hubcap body 102 so that the entire wheel hub 202 and wheel mounted on the hub 202 may be removed from the axle 204 without having to remove the hubcap body 102 from the wheel hub 202. Removal of the endcap 402 may also allow inspection of the wheel bearings through the open distal end 112 of the hubcap body 102. Thus, the threaded endcap 402 allows certain maintenance activities to be performed without removing the bolts 122 fastening the hubcap body 102 to the wheel hub 202. Although some types of hubcaps may be designed to be threaded directly onto wheel hubs 202 (such as the hubcap assembly 100 shown in FIG. 3), many commonly used hubcaps, such as those commonly used in the trucking industry, are mounted onto the wheel hub using bolts 122. Thus, the present hubcap assembly 100 with a threaded endcap 402 may simplify routine maintenance activities for bolted hubcaps.

The threaded endcap 402 also allows the filter element 300 to be removed from the enclosure 108 without removing the hubcap body 102 from the wheel hub 202 by removing the cap assembly 400 as a unit, including the filter element 300. The filter element 300 may then be removed from the cap assembly 400 by removing the fastener ring 422 and viewing window 428 to access the filter element 300. The filter element 300 may be reusable and may be cleaned and re-installed in the threaded endcap 402. After removal of the cap assembly 400 from the hubcap body 102, the filter element 300 may also be cleaned in place without removing the filter element 300 from the endcap 402. For instance, the filter element 300 may be cleaned by spraying a fluid cleaning agent onto the filter element 300 through the openings 416 in the filter retaining structure 412 and/or physically removing filtered contaminants through the openings 416 in the filter retaining structure 412. The cleaning agent may be a brake cleaner or other similar type of cleaning agent suitable for degreasing and cleaning metal parts. Alternatively, the filter element 300 may be removably secured to the proximal end 406 of the endcap 402 by a mechanism that allows the filter element 300 to be removed from the endcap 402 without removal of the fastener ring 422 and viewing window 428. It should be understood by one of skill in the art that different fastening devices may be utilized to secure the filter element 300 to the cap assembly 400 and still fall within the scope of the present disclosure. For instance, various types of clips, clamps, pins, snap-on fasteners, quick-connect fasteners, or any other suitable type of fastener may be alternatively utilized to secure the filter element 300 to the cap assembly 400 without departing from the scope of the present disclosure. In another alternative embodiment, a reusable filter element 300 may be permanently attached to the threaded endcap 402. The hubcap assembly 100 with threaded endcap 402 may also be utilized without the filter element 300. In such cases, the threaded endcap 402 may be utilized to seal the oil enclosure 108 and to provide access to the torque nut and bearings for maintenance without requiring removal of fasteners 122 and the hubcap body 102.

Once the cap assembly 400 is fully installed, the transparent viewing window 428 allows a user to visually observe an oil level within the holding chamber 132 from an exterior of the hubcap assembly 100. The viewing window 428 may be made of a generally transparent material such as plastic or glass. Thus, the user may observe whether there is an adequate amount of oil inside the hubcap assembly 100 to determine if additional oil should be added. The user may also observe the color of the oil to determine the oil quality and thus whether the oil should be changed. As oil splashes and otherwise moves within the interior of the hubcap body 102 and through the filter element 300 during operation of the vehicle, the filter element 300 may remove contaminants from the oil and retain the contaminants on or within the filter. The filter element 300 may comprise a barrier filtration media, one or more magnets configured to remove metal shavings from the oil, or a combination of magnets and barrier filtration media. The barrier filtration media may be utilized to remove dirt, debris, or any other type of contaminant capable of being removed through barrier filtration of oil. The design of the filtration assembly 300 effectively removes contaminants from the oil to extend the life of the oil between oil changes and thus enhance bearing lubrication through extended periods of use.

FIGS. 11-13 illustrate a disc filter element 300 that may be used with the cap assembly 400 to filter oil contained within the oil enclosure 108 via barrier filtration. The filter element 300 comprises two opposing wire mesh filters 304 supported by a perforated support plate 302 that is disposed between the wire mesh filters 304, as shown in FIG. 12B. The filter element 300 may include an outer clamping ring 308 and two inner clamping rings 310. Each of the clamping rings 308, 310 may have a C-shaped channel that can be clamped onto components of the filter element 300. The outer clamping ring 308 may have an inwardly facing channel that is clamped to retain the support plate 302 and both of the wire mesh filters 304. The inner clamping rings 310 may each have an outwardly facing channel that is clamped to retain a respective one of the wire mesh filters 304. The filter element 300 may optionally include an addition layer of a mesh filter 306 disposed on the inner side of each of the wire mesh filters 304 to provide an additional layer of filtration. The optional additional mesh filters 306 may also be retained by the outer clamping ring 308 and a respective one of the inner clamping rings 310. The support plate 302 has a plurality of perforations or openings 315 (visible through mesh filter 304 in FIGS. 11 and 13) to allow oil to flow through the support plate 302, which is preferably made of a non-permeable material such as metal, by flowing through the mesh filters 304 and the openings 315.

Preferably, the filter element 300 has a central opening 312 that extends through the filter element 300. The support plate 302 may have bends in a portion of the plate 302 adjacent to the central opening 312, and the support plate 302 may then flatten as the plate 302 extends from the bends at the central opening 312 toward the outer clamping ring 308 at the outer peripheral edge 316 of the filter element 300, as shown in FIG. 12B. Each of the inner clamping rings 310 may be attached to opposing sides of the support plate 302 at the bended portion of the plate 302 so that the inner clamping rings 310 define an edge of the central opening 312. As best seen in FIG. 13, the bends of the support plate 302 form openings 314 between the two inner clamping rings 310 at the central opening 312, which provides spacing between the support plate 302 and each of the opposing wire mesh filters 304.

The central opening 312 may facilitate the flow of oil between the holding chamber 132 and the other portions of the enclosure 108 on the proximal side of the filter element 300, which may increase the flow of oil through the filter element 300. Some oil may flow through the central opening 312, through the indentations 436 in the extension element 432 of the viewing window 428, into the holding chamber 132, and then back through the mesh filters 304. Additionally, some oil that flows through the central opening 312 may flow into the filter element 300 through openings 314 and then out of the filter element 300 through one of the wire mesh filters 304.

The wire mesh filters 304 may comprise a plurality of woven wires having a plurality of openings extending through the mesh and being defined by spaces between the woven wires. The woven wires may be made of stainless steel, copper, or another suitable material. The woven wires may be sintered so that the individual wires are bonded to each other at each intersection of wires. Each mesh filter 304 may be a surface filter designed to remove contaminants from the oil as the oil passes through the openings in the mesh. In some embodiments, the surface filter may have pore sizes up to about 2,000 microns and preferably ranging from about 25 to 750 microns. In one embodiment, one or both of the mesh filters 304 may be a magnetic mesh filter comprising a plurality of magnetic woven wires capable of magnetic filtration and barrier filtration. The wires forming the mesh may be made of material having magnetic characteristics such that the mesh filter 304 produces a magnetic field capable of attracting ferromagnetic particles contained in the oil. For instance, the wires forming the mesh may be made of a magnetic stainless steel, such as ferritic stainless steel, martensitic stainless steel, or duplex stainless steel. The magnetic stainless steel may be an alloy including ferritic or martensitic crystal structures to provide magnetic properties, such as 430 grade stainless steel. The optional additional layer of mesh filter 306 may be made of a sintered metal fiber felt.

In one embodiment, one or both of the wire mesh filters 304 of the filter element 300 may comprise a coated mesh filter, which may be used in combination with a magnetic or non-magnetic mesh filter. The coated mesh filter may comprise a plurality of woven wires coated with a hydrophobic material adapted to allow the passage of oil through the openings of the coated mesh filter and to prevent the passage of water through the coated mesh filter. For instance, the wires forming a woven mesh filter 304 may be coated with a polytetrafluoroethylene (PTFE) resin or a similar hydrophobic material to provide a hydrophobic filter element that separates oil from any water that may have contaminated the oil. The coating may be a thin coating that does not close any of the openings in the mesh. The coating may cause water to bead on the surface of the mesh while allowing other liquid to pass through the mesh. When utilizing a coated mesh filter 304, the coated mesh filter is preferably disposed on the distal or outward side of the filter element 300. In this case, any aqueous contaminant that may enter the holding chamber 132 through any component of the cap assembly 400, for instance, in the case of a leak around edges of the viewing window 428, will not pass through the coated mesh filter 304 into the proximal side of the oil enclosure 108, which would expose the wheel bearings to the aqueous contaminant.

FIGS. 14-20 illustrate a filter element 300 comprising one or more baffle plates 318 each having a plurality of openings 320 extending through the baffle plate 318 to allow oil to flow through the openings 320. The baffle plate 318 may include magnetic elements attached to the baffle plate 318 for removal of ferromagnetic contaminants primarily. In one embodiment, as shown in FIGS. 14 and 15, the filter element 300 may comprise a generally flat baffle plate 318 and a plurality of ring-shaped magnets 322 each attached to the baffle plate 318 and each having an opening extending through the ring-shaped magnet 322. Each opening extending through a respective one of the plurality of ring-shaped magnets 322 may define a respective one of a plurality of openings 320 extending through the baffle plate 318. FIG. 15 shows an exploded view of the filter element 300 with one of the plurality of magnets 322 removed from the baffle plate 318. The baffle plate 318 may be a generally circular disc having a plurality of circular openings 324 sized to receive a respective one of the ring-shaped magnets 322 therein. When installed within one of the openings 324, surfaces on opposing sides of each of the ring-shaped magnets 322 may be generally flush with exterior surfaces on opposing sides of the baffle plate 318. Each of the ring-shaped magnets 322 may be press-fit into one of the openings 324 in the baffle plate 318 or otherwise attached to the baffle plate 318. The openings 320 defined by the magnets 322 and extending through the assembled baffle plate 318 allow the oil to flow across the filter element 300 while increasing the surface area that contacts the oil for magnetic separation of ferromagnetic contaminants from the oil.

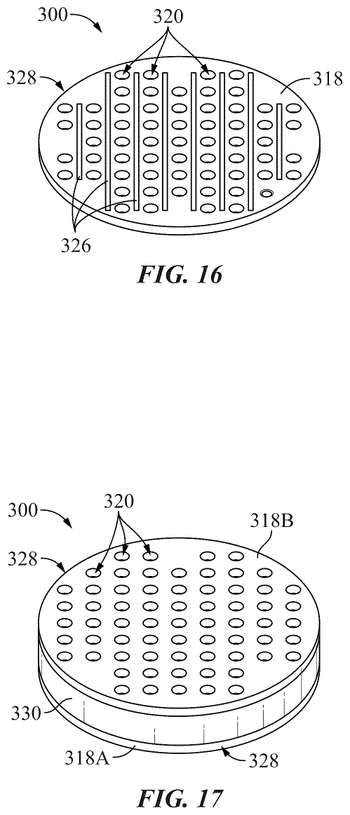

Alternatively, as shown in FIG. 16, the filter element 300 may comprise a generally flat baffle plate 318 and a plurality of magnetic elements 326 attached to an exterior surface of the baffle plate 318. The magnetic elements 326 may comprise sheets of magnetic material formed into strips and attached to the exterior surface of the baffle plate 318 on at least one side of the baffle plate 318, and preferably on at least the proximal side of the baffle plate 318 when the baffle plate 318 is secured to the cap assembly 400. The magnetic strips 326 may be positioned on the surface of the baffle plate 318 in rows between rows of openings 320 in the baffle plate 318. The openings 320 extending through the baffle plate 318 allow the oil to flow across the filter element 300 while the oil also contacts the magnetic strips 326 for magnetic separation of ferromagnetic contaminants.

FIGS. 17-20 illustrate a filter element 300 comprising two opposing baffle plates 318A and 318B each having a plurality of openings 320 extending through each of the two baffle plates 318A and 318B to allow oil to flow through the openings 320 of both baffle plates and through the filter element 300. The two opposing baffle plates 318A and 318B may be disposed generally parallel to each other, and a sidewall 330 may extend between the two baffle plates 318A and 318B and attach the baffle plates 318A and 318B to each other. The sidewall 330 may be a continuous sidewall 330 extending around an outer peripheral edge 328 of each of the two circular baffle plates 318A and 318B or may optionally have openings in the sidewall 330. Similar to the single baffle plates 318 shown in FIGS. 14-16, one or both of baffle plates 318A and 318B may optionally have magnetic elements 322, 326 attached to a surface of the baffle plate 318A, 318B. Alternatively, one or both of baffle plates 318A and 318B may be made of magnetic stainless steel or a similar material having magnetic characteristics.

As best seen in FIGS. 19 and 20, the filter element 300 may further comprise barrier filtration media disposed between the opposing baffle plates 318A and 318B. The barrier filtration media 332, 334 may comprise any type of filtration media suitable for physical removal of contaminants such as dirt and debris from oil contained within a wheel hub for lubricating wheel bearings. The barrier filtration media may comprise depth filter media 332, a surface filter 334, or both a surface filter 334 and a depth filter 332. The surface filter 334 may comprise a woven wire mesh filter, which may be the same or similar to wire mesh filter 304 as described herein. Thus, the surface filter 334 may comprise a plurality of woven wires having a plurality of openings extending through the mesh and being defined by spaces between the woven wires. The woven wires may be made of stainless steel, copper, or another suitable material. The woven wires may be sintered so that the individual wires are bonded to each other at each intersection of wires. The mesh filter 334 may be a magnetic mesh filter comprising a plurality of magnetic woven wires capable of magnetic filtration and barrier filtration. The mesh filter 334 may be secured to an interior side of the sidewall 330 of the filter element 300 using clips 336 or another suitable type of fastener to retain the mesh filter 334 in a fixed position between the baffle plates 318A and 318B of the filter element 300.

The optional depth filter 332 may have a density that provides passageways having a size through which the oil may flow through the media 332 and between the oil enclosure 108 on the proximal side of the filter element 300 and the holding chamber 132 on the distal side of the filter element 300 during operation of the vehicle, thereby filtering contaminants from the oil. In some embodiments, the depth filter media 332 may comprise a wire wool material, such as stainless steel wool, or a similar type of filtration material comprising entwined filaments that are agglomerated to form a depth filter having passageways capable of retaining various types of contaminants throughout the filtration media. The depth filter media 332 may optionally comprise material that is sintered. Due to the agglomerated nature of the entwined filaments, the sizes of the passageways formed by the filaments throughout the media 332 may vary. In some embodiments, the depth filter media 332 may have internal passageways having sizes or diameters up to about 2,000 microns, and preferably in the range of approximately 25 to 750 microns. In some embodiments, the depth filter media 332 may comprise cellulose fibers, synthetic glass fibers, polyester fibers, or other types of natural or synthetic fibers.

Each of the filter elements 300 comprising one or more baffle plates 318 may be secured to the cap assembly 400 in the same manner as the disc filter elements 300 shown in FIGS. 11-13. Thus, each of the filter elements 300 comprising one or more baffle plates 318 may be positioned against the filter retaining structure 412 and retained in place by positioning the extension element 432 of the viewing window 428 adjacent to the filter element 300 and securely fastening the viewing window 428 to the threaded endcap 402. The dimensions of the extension element 432 of the viewing window 428 may be varied to accommodate a specific filter element 300 of a defined thickness.

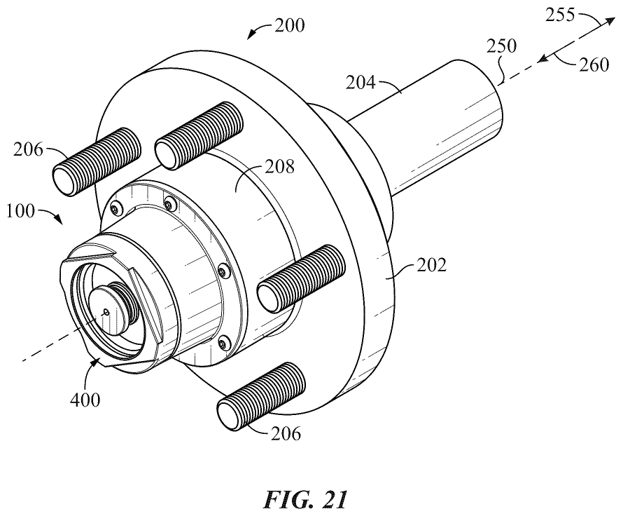

FIGS. 21-23 show an alternative embodiment of the hubcap assembly 100 in which the helical threads 116A of the threaded section of the distal end 112 of the hubcap body 102 comprise male threads disposed on an exterior side of a wall of the hubcap body 102, and the helical threads 404A of the threaded endcap 402 comprise female threads. The cap assembly 400 comprises a threaded endcap 402, a transparent viewing window 428 having an opening 430 extending through the viewing window 428, and a plug 438 configured to be installed within the opening 430 in the viewing window 428 to seal the opening 430. The cap assembly 400 may include a gasket 426 positioned on the proximal side of the viewing window 428. The interior wall 104 of the hubcap body 102 may have an interior edge 134 sized and configured so that the gasket 426 may be positioned flat against the interior edge 134 when installed. Thus, to seal the enclosure 108, the gasket 126 and viewing window 128 may be positioned onto the distal end 112 of the hubcap body 102, and the threaded endcap 402 may be threaded onto the open distal end 112 by mating threads 404A with threads 116A. As the endcap 402 is rotated to thread the endcap 402 onto the hubcap body 102, an interior side of the endcap 402 is pressed against the exterior or distal side of the viewing window 128. The gasket 426 and increased pressure applied by rotating the endcap 402 then form a seal to seal the distal end 112 of the hubcap body 102. As best seen in FIG. 22, the threaded endcap 402 may have an engagement portion 454 having angled edges to allow engagement with a wrench for rotating the endcap 402 to tighten or loosen the endcap 402. The engagement portion 454 is preferably permanently attached to the endcap 402 and may be molded, machined, or otherwise integrally formed with the endcap 402. To complete the installation, the plug 438 may be installed within opening 430 in the viewing window 428 to seal the opening 430.

Preferably, the cap assembly 400 further comprises a filter element 300 and a filter retaining structure. The filter retaining structure preferably comprises a filter support plate 450 that is not directly structurally attached to the threaded endcap 402. The threaded endcap 402 is configured to securely fasten the viewing window 128, the filter element 300, and the support plate 450 to the hubcap body 102 when the threaded endcap 402 is threaded onto the distal end 112 of the hubcap body 102. The support plate 450 has a plurality of openings 452 extending through the support plate 450 to allow oil to flow through the filter element 300 that is retained by the support plate 450. Because the support plate 450 is not directly attached to the threaded endcap 402, the filter element 300 and the support plate 450 may be removed directly from the hubcap assembly 100 immediately upon removal of the threaded endcap 402 from the hubcap body 102. The viewing window 428 is preferably also not structurally attached to the endcap 402 and may thus be separated from the endcap 402 by removing the endcap 402 from the hubcap body 102.

The interior wall 104 of the hubcap body 102 that defines enclosure 108 preferably has a lip 136 extending inwardly from the interior wall 104 around a perimeter of the interior wall 104, as best seen in FIGS. 22 and 23. The filter support plate 450 may have an outer diameter that is larger than an inner diameter of the lip 136 and smaller than an inner diameter of the hubcap body 102. The filter support plate 450 may thus be inserted into the open distal end 112 of the hubcap body 102 and then positioned against the lip 136 so that the lip 136 supports the filter support plate 450. Alternatively, the filter support plate 450 may be permanently attached to the interior wall 104 of the hubcap body 102. The filter support plate 450 is configured to support the filter element 300 in a generally transverse position relative to the threaded endcap 402. To install the filter element 300, the filter support plate 450 may be positioned against the lip 136, and the filter element 300 may then be positioned against the filter support plate 450. The viewing window 428 may then be positioned against interior edge 134 of the hubcap body 102 (with gasket 426 between the interior edge 134 and the viewing window 428), which may cause an extension element 432 extending in an axially inwardly direction from the viewing window 428 to be positioned generally adjacent to the filter element 300, as best seen in FIG. 23. The extension element 432 is configured to retain the filter element 300 in a position between the extension element 432 and the filter support plate 450. The endcap 402 may then be threaded onto the distal end 112 of the hubcap body 102 and tightened until the gasket 426 and endcap 402 form a sufficiently tight seal. Once the threaded endcap 402 is threaded onto the distal end 112 of the hubcap body 102 and tightened, the endcap 402 then securely fastens the viewing window 428, the filter element 300, and the filter support plate 450 to the hubcap body 102.

Alternatively, the cap assembly 400 may include a threaded endcap 402 with male threads 404 in combination with a filter support plate 450 that is not structurally attached to the endcap 402, or the cap assembly 400 may include a threaded endcap 402 with female threads 404A in combination with a filter retaining structure 412 that is structurally attached to the endcap 402.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1.) A hubcap assembly comprising:
a hubcap body configured to be removably mounted onto a wheel hub, wherein an
interior wall of the hubcap body defines an oil enclosure, wherein the hubcap body has a distal end that defines an opening at the distal end, wherein the hubcap body has a threaded section having helical threads at the distal end; and
a cap assembly configured to cap the opening at the distal end of the hubcap body,
wherein the cap assembly comprises:
a threaded endcap having helical threads that are compatible with the helical threads of the hubcap body; and
a filter element secured to the threaded endcap, wherein the filter element is disposed within the oil enclosure when the threaded endcap is threaded onto the distal end of the hubcap body.

2.) The hubcap assembly of claim 1, wherein the threaded endcap has a proximal end and a distal end, wherein the threaded endcap has an interior wall extending around an inner perimeter of the threaded endcap, wherein the interior wall is disposed between the proximal end and the distal end, wherein the proximal end comprises a filter retaining structure that extends transversely across a width of the threaded endcap between opposing surfaces of the interior wall, wherein the filter retaining structure is configured to support the filter element in a transverse position relative to the threaded endcap, wherein the filter retaining structure defines at least one opening extending through the filter retaining structure.

3.) The hubcap assembly of claim 2, wherein the cap assembly further comprises a viewing window and a fastening ring, wherein the fastening ring is configured to be removably secured to the threaded endcap, wherein the fastening ring is further configured to retain the viewing window in a fixed position on the endcap.

4.) The hubcap assembly of claim 3, wherein the viewing window comprises an extension element that extends from the viewing window in an axially inward direction when the viewing window is retained in a fixed position by the fastening ring, wherein the extension element is configured to retain the filter element in a position between the extension element and the filter retaining structure.

5.) The hubcap assembly of claim 4, wherein the extension element has a peripheral edge that extends continuously around an opening extending through the viewing window, wherein the peripheral edge of the extension element defines a plurality of indentations disposed around the opening extending through the viewing window.

6.) The hubcap assembly of claim 1, wherein the filter element comprises a mesh filter.

7.) The hubcap assembly of claim 6, wherein the mesh filter comprises a plurality of magnetic woven wires.

8.) The hubcap assembly of claim 6, wherein the mesh filter comprises a coated mesh filter comprising a plurality of woven wires coated with a hydrophobic material adapted to allow passage of oil through the coated mesh filter and to prevent passage of water through the coated mesh filter.

9.) The hubcap assembly of claim 1, wherein the filter element comprises at least one baffle plate having a plurality of openings extending through the at least one baffle plate, wherein the at least one baffle plate has a magnet attached to the at least one baffle plate.

10.) The hubcap assembly of claim 1, wherein the filter element comprises two opposing baffle plates, wherein each respective one of the opposing baffle plates has a plurality of openings extending through the baffle plate, wherein the filter element further comprises barrier filtration media disposed between the opposing baffle plates, wherein the barrier filtration media comprises a surface filter, a depth filter, or both a surface filter and a depth filter.

11.) A hubcap assembly comprising:
a hubcap body having a proximal end and a distal end, wherein a central opening extends through the hubcap body from the proximal end to the distal end to define an opening at the proximal end and an opening at the distal end,
wherein the proximal end of the hubcap body has a plurality of fastener openings configured for removably mounting the hubcap body onto a wheel hub using a plurality of fasteners,
wherein the distal end of the hubcap body has a threaded section having helical threads; and
a cap assembly configured to cap the opening at the distal end of the hubcap body, wherein the cap assembly comprises a threaded endcap having helical threads that are compatible with the helical threads of the hubcap body.

12.) The hubcap assembly of claim 11, wherein the proximal end of the hubcap body has a flange, wherein each of the plurality of fastener openings extends through the flange.

13.) The hubcap assembly of claim 11, wherein the helical threads of the threaded section of the distal end of the hubcap body comprise female threads disposed on an interior side of a wall of the hubcap body, and wherein the helical threads of the threaded endcap comprise male threads.

14.) The hubcap assembly of claim 13, wherein the hubcap assembly further comprises a filter element secured to the threaded endcap, wherein the threaded endcap has a proximal end and a distal end, wherein the threaded endcap has an interior wall extending around an inner perimeter of the threaded endcap, wherein the interior wall is disposed between the proximal end and the distal end, wherein the proximal end comprises a filter retaining structure that extends transversely across a width of the threaded endcap between opposing surfaces of the interior wall, wherein the filter retaining structure is configured to support the filter element in a transverse position relative to the threaded endcap, wherein the filter retaining structure defines at least one opening extending through the filter retaining structure.

15.) The hubcap assembly of claim 14, wherein the cap assembly further comprises a viewing window and a fastening ring, wherein the fastening ring is configured to be removably secured to the threaded endcap, wherein the fastening ring is further configured to retain the viewing window in a fixed position on the endcap.

16.) The hubcap assembly of claim 15, wherein the viewing window comprises an extension element that extends from the viewing window in an axially inward direction when the viewing window is retained in a fixed position by the fastening ring, wherein the extension element is configured to retain the filter element in a position between the extension element and the filter retaining structure.

17.) The hubcap assembly of claim 16, wherein the extension element has a peripheral edge that extends continuously around an opening extending through the viewing window, wherein the peripheral edge of the extension element defines a plurality of indentations disposed around the opening extending through the viewing window.

18.) The hubcap assembly of claim 11, wherein the helical threads of the threaded section of the distal end of the hubcap body comprise male threads disposed on an exterior side of a wall of the hubcap body, and wherein the helical threads of the threaded endcap comprise female threads.

19.) The hubcap assembly of claim 18, wherein the hubcap assembly further comprises:
a viewing window;
a filter element; and
a filter support plate having at least one opening extending through the filter support plate,
wherein the hubcap body has an interior wall that defines an enclosure, wherein the interior wall has a lip extending inwardly from the interior wall around a perimeter of the interior wall,
wherein the filter support plate has an outer diameter that is larger than an inner diameter of the lip and smaller than an inner diameter of the hubcap body, wherein the filter support plate is configured to support the filter element in a transverse position relative to the threaded endcap, and
wherein the threaded endcap is configured to securely fasten the viewing window, the filter element, and the filter support plate to the hubcap body when the threaded endcap is threaded onto the distal end of the hubcap body.

20.) The hubcap assembly of claim 19, wherein the viewing window comprises an extension element that extends from the viewing window in an axially inward direction when the viewing window is fastened to the hubcap body, wherein the extension element is configured to retain the filter element in a position between the extension element and the filter support plate.
